(19) United States
(12) Patent Application Publication
(10) Pub. No.: US 2026/0077587 A1
(43) Pub. Date: Mar. 19, 2026

(54) LIQUID DISCHARGE HEAD

(71) Applicant: CANON KABUSHIKI KAISHA, Tokyo (JP)

(72) Inventors: KAZUNARI ISHIZUKA, Shizuoka (JP); TOSHIO NEGISHI, Kanagawa (JP)

(21) Appl. No.: 19/323,705

(22) Filed: Sep. 9, 2025

(30) Foreign Application Priority Data
Sep. 13, 2024 (JP) 2024-159098
Jun. 17, 2025 (JP) 2025-101373

(51) Int. Cl. B41J 2/045; B41J 2/14; B41J 2/16

(52) U.S. Cl. CPC B41J 2/04543; B41J 2/04541; B41J 2/04573; B41J 2/0458; B41J 2/14072; B41J 2/1601; B41J 2002/14491; B41J 2202/12

(57) ABSTRACT

A liquid discharge head includes a plurality of discharging modules having a discharging drive element and a discharging heater electrically connected to the discharging drive element; a plurality of circulating modules having a circulating drive element and a circulating heater electrically connected to the circulating drive element, the circulating modules being arranged in pair with the discharging modules, and a number of the circulating modules being the same as a number of the discharging modules; a latch circuit for latching a data signal including selection information for selecting each of the plurality of discharging modules and the plurality of circulating modules; and a control unit for selectively controlling a first set of circulating modules or a second set of circulating modules based on a count value of edges of latch signals producing latch timing.

### BACKGROUND

### Field of the Technology

The present disclosure relates to a liquid discharge head that discharges a liquid while circulating the liquid.

### Description of the Related Art

There is a known circulation type liquid discharge apparatus for circulating a liquid (referred to also as ink) in which ink is circulated in a circulation flow channel in communication with a discharge orifice by a circulating drive element provided in addition to a discharging drive element for discharging ink. Japanese Translation of PCT International Application Publication No. 2020-507497 (referred to as Patent Literature 1 hereinafter) discloses a technique of selectively driving either a discharging drive element or a circulating drive element.

### SUMMARY

The present disclosure discloses advantageous features to drive, in a discharge element substrate including discharging drive elements and circulating drive elements, the circulating drive elements an optimal number of times of driving while reducing the amount of transferred data and avoiding intensive power consumption of some of the circulating drive elements.

According to some embodiments of the present disclosure, a liquid discharge head includes a plurality of discharging modules having a discharging drive element and a discharging heater electrically connected to the discharging drive element; a plurality of circulating modules having a circulating drive element and a circulating heater electrically connected to the circulating drive element, the circulating modules being arranged in pair with the discharging modules, and a number of the circulating modules being the same as a number of the discharging modules; a latch circuit for latching a data signal including selection information for selecting each of the plurality of discharging modules and the plurality of circulating modules; and a control unit for selectively controlling a first set of circulating modules or a second set of circulating modules among the plurality of circulating modules based on a count value of edges of latch signals producing latch timings for the latch circuit to latch the data signal, the second set of circulating modules arranged in a different placement area than the first set of circulating modules.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view schematically showing a liquid discharge apparatus with a main ink tank as a liquid reservoir provided outside of a liquid discharge head 1.

FIG. 1B is a perspective view schematically showing the liquid discharge apparatus with an ink sub tank provided directly above the liquid discharge head.

FIG. 2A is an exploded perspective view of the liquid discharge head in FIGS. 1A and 1B.

FIG. 2B is a diagram showing a case where one liquid discharge chip is provided for four colors.

FIG. 2C is a diagram showing a case where one liquid discharge chip is provided for two colors.

FIG. 2D is a diagram showing a case where one liquid discharge chip is provided for one color.

FIG. 3A is a plan view of an individual discharge unit viewed from a direction in which a droplet is discharged from a discharge orifice.

FIG. 3B is a cross-sectional view taken along the line IIIb-IIIb in FIG. 3A.

FIG. 3C is a cross-sectional view taken along the line IIIb-IIIb in FIG. 3A in which the configuration in a substrate is different from that shown in FIG. 3B.

FIG. 3D is a diagram illustrating an inflow of ink into a pressure chamber in a case where a first energy generating element is driven.

FIG. 4A is a cross-sectional view of the individual discharge unit taken along the line IIIb-IIIb in FIG. 3A for illustrating a generation and development process of a bubble generated by film boiling of ink heated by a second energy generating element.

FIG. 4B is a cross-sectional view of the individual discharge unit taken along the line IIIb-IIIb in FIG. 3A for illustrating a contraction process of the bubble generated by film boiling of ink heated by the second energy generating element.

FIG. 4C is a cross-sectional view of the individual discharge unit taken along the line IIIb-IIIb in FIG. 3A for illustrating a process after disappearance of the bubble generated by film boiling of ink heated by the second energy generating element.

FIG. 5A is a diagram showing a state where a circulatory flow of ink is temporarily stopped.

FIG. 5B is a diagram showing a state immediately after the circulatory flow of ink is produced by driving the second energy generating element after the state shown in FIG. 5A.

FIG. 5C is a diagram showing a state where the circulatory flow of ink is temporarily stopped after the state shown in FIG. 5B.

FIG. 5D is a diagram showing a state immediately after the circulatory flow of ink is produced by driving the second energy generating element after the state shown in FIG. 5C.

FIG. 6A is a diagram showing a state where the circulatory flow of ink is temporarily stopped.

FIG. 6B is a diagram showing a state immediately after the circulatory flow of ink is produced by driving the second energy generating element after the state shown in FIG. 6A.

FIG. 6C is a diagram showing a state where the circulatory flow of ink is temporarily stopped after the state shown in FIG. 6B.

FIG. 6D is a diagram showing a state immediately after the circulatory flow of ink is produced by driving the second energy generating element after the state shown in FIG. 6C.

FIG. 7 is a diagram showing an example circuit configuration of a discharge element substrate of the liquid discharge chip in FIG. 2A.

FIG. 8A is a functional block diagram of a circuit configuration of a control data supply circuit.

FIG. 8B is a diagram showing a circuit configuration of a circulating group control circuit.

FIG. 9 is a timing chart showing a relationship between latch signals, latch counter signals and decoder signals of a latch counter circuit and a decoder circuit.

FIG. 10 is a plan view of a discharge element substrate in a first case.

FIG. 11 is a plan view of a discharge element substrate in a second case.

FIG. 12 is a plan view of a discharge element substrate in a third case.

### DESCRIPTION OF THE EMBODIMENTS

In the following, a various exemplary embodiments, features, and aspects of the present disclosure will be described with reference to the accompanying drawings. Note that the embodiment described below is not intended to limit the present disclosure, and all the combinations of the features of the embodiment described below are not necessarily essential for the solution of the present disclosure. Note that the same components are denoted by the same reference numerals.

### (Overview)

A circulation-type liquid discharge apparatus that circulates ink is known. The liquid discharge apparatus has a liquid discharge head. The ink is circulated in order to discharge bubbles in the flow channel of the liquid discharge head and to prevent thickening of the ink in the vicinity of the discharge orifice. As for circulating the ink, for example, a method that uses the pressure difference (referred to also as a “differential pressure method” hereinafter) is well known. In the differential pressure method, a pressure adjustment mechanism or the like is used to set a higher pressure on the side where the ink is supplied to the discharge orifice (referred to also as an in-side) than on the side where the ink is collected (referred to also as an out-side). By setting the pressure difference in this way, the ink can flow from the in-side to the out-side. Here, in order to circulate the ink, the ink having flowed to the out-side need to be fed back to the in-side. To this end, the mechanism uses a pump. Note that some liquid discharge apparatuses have a pump provided outside of the liquid discharge head and circulate ink between the liquid discharge head and a main unit of the liquid discharge apparatus. Other liquid discharge apparatuses have a pump provided inside the liquid discharge head and circulate ink in the liquid discharge head. However, the differential pressure type circulation method uses the pressure adjustment mechanism, the pump and other mechanisms. Therefore, the main unit of the discharge apparatus and the liquid discharge head tend to have a large size.

In view of this, there is an ink circulation method other than the differential pressure method as described below. That is, in addition to the discharging drive element for discharging ink, a circulating drive element is provided in the circulation flow channel in communication with the discharge orifice. There is known a mechanism that has such a configuration and drives the circulating drive element to circulate ink in the circulation flow channel.

Furthermore, there is disclosed a circuit configuration for selectively driving each of a plurality of discharging drive elements and a plurality of circulating drive elements provided on a discharge element substrate included in a liquid discharge head. With such a circuit configuration, an address is assigned to each of the plurality of discharging drive elements and the plurality of circulating drive elements, thereby realizing a function of selectively driving each of the plurality of discharging drive elements and the plurality of circulating drive elements. Therefore, as the number of the plurality of discharging drive elements and the plurality of circulating drive elements increases, the amount of transferred data of the data signals for specifying individual addresses increases. As the amount of transferred data increases, the number of circuits that address problems such as crosstalk between data signals increases, and therefore, the amount of transferred data is preferably reduced. In order to reduce the amount of transferred data, a configuration may be considered in which the selection information for the circulating drive elements is converted in the discharge element substrate in accordance with the selection information for the discharging drive elements and each of the circulating drive elements is selected.

For example, when a heater is used as an energy generating element, the discharging drive element serving as a discharging heater may be selected when the discharging heater-on selection signal is “1”. When a heater is used as an energy generating element, the circulating drive element serving as a circulating heater may be selected when the discharging heater-on selection signal is “0”. With such a configuration, the amount of transferred data can be reduced.

However, even with such a configuration, each of the discharging drive element and the circulating drive element is selected by a data signal with the same driving frequency. In the first place, the optimal timing of discharging ink and the optimal timing of circulating ink are different. For example, when the driving frequency of the discharging drive element>>the driving frequency of the circulating drive element, if the circulating drive element or the discharging drive element is exclusively controlled, the circulating drive element is more frequently driven than needed. Therefore, the power consumption may not be reduced.

Furthermore, with the configuration described above, even though the number of times of driving of the discharging drive element>>the number of times of driving of the circulating drive element, the circulating drive element is inevitably turned on when the discharging drive element is turned off. Therefore, there is a need for a mechanism capable of appropriately setting the number of times of driving of the circulating drive element, from the viewpoint of reducing the power consumption.

Furthermore, in driving of circulating drive elements, a large number of circulating drive elements may be turned on at the same time, and intensive power consumption may occur. If intensive power consumption occurs in some of the circulating drive elements, the load on the power supply of the liquid discharge apparatus that is an inkjet recording apparatus increases. Therefore, there is a need for a mechanism capable of appropriately setting the number of circulating drive elements turned on at the same time.

In other words, according to the inventor's research, it was found that with a discharge element substrate including discharging drive elements and circulating drive elements according to prior art, the circulating drive elements cannot be driven an optimal number of times of driving while reducing the amount of transferred data and avoiding intensive power consumption of some of the circulating drive elements.

In view of this, according to the present disclosure, at least latch signals for latching an input data signal for specifying discharging modules having discharging drive elements are counted. Circulating drive elements are controlled to be drivable state until a cumulative count value obtained by counting latch signals exceeds a first threshold value and a differential count value obtained by counting latch signals by the cumulative count value as a starting point exceeds a second threshold value. Such a process can reduce the total time for which the circulating drive elements are driven and therefore can reduce the power consumption.

Furthermore, according to the present disclosure, based on the count value of edges of latch signals, a first set of circulating modules or a second set of circulating modules among a plurality of circulating modules is selectively controlled and the second set of circulating modules is arranged in a different placement area than the first set of circulating modules. Each of the latch signals is a signal that produces a data signal latch timing including selection information for selecting each of the plurality of discharging modules and the plurality of circulating modules. With such a configuration, the amount of transferred data can be reduced. In addition, since the first set of circulating modules or the second set of circulating modules arranged in a different placement area than the first set of circulating modules is selectively controlled, intensive power consumption due to driving of the circulating drive elements can be avoided, and the power consumption can be reduced.

### <Liquid Discharge Apparatus 50>

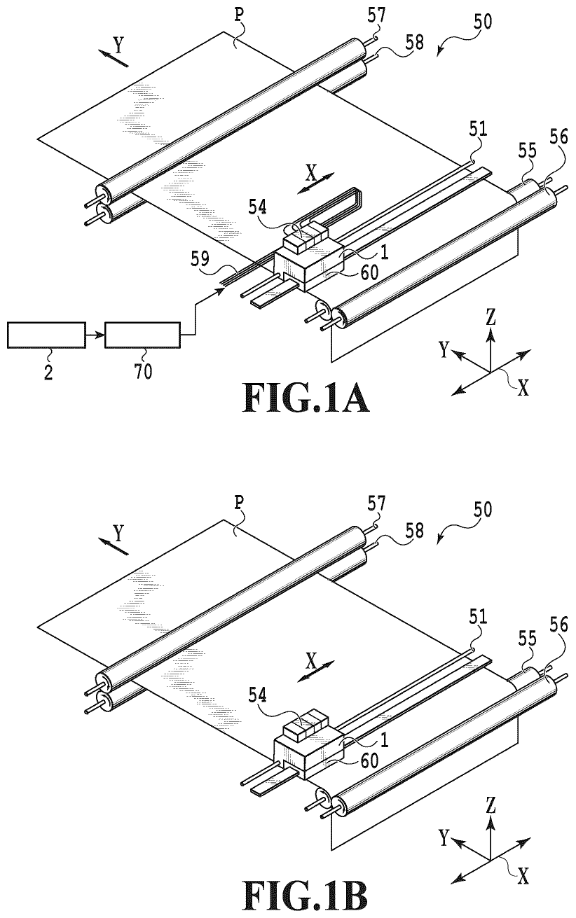

FIGS. 1A and 1B are diagrams showing examples of general configurations of a liquid discharge apparatus 50. FIG. 1A is a perspective view schematically showing the liquid discharge apparatus 50 with a main ink tank 2 as a liquid reservoir provided outside of a liquid discharge head 1. FIG. 1B is a perspective view schematically showing the liquid discharge apparatus 50 with an ink sub tank 54 provided directly above the liquid discharge head 1. Parts common to FIGS. 1A and 1B will be first described.

The liquid discharge apparatus 50 includes the liquid discharge head 1 and conveyance rollers 55, 56, 57 and 58. The liquid discharge head 1 can scan in a direction X orthogonal to a conveyance direction Y of a medium-to-be-discharged P. The liquid discharge head 1 is mounted on a carriage 60. The carriage 60 moves back and forth in a main scan direction (referred to also as the direction X) along a guide shaft 51. The conveyance rollers 55, 56, 57 and 58 convey the medium-to-be-discharged P in a sub scan direction (referred to also as the conveyance direction Y) that intersects with (is orthogonal to, in this embodiment) the main scan direction. That is, the liquid discharge apparatus 50 constitutes a serial type ink jet discharge apparatus that forms an image by discharging a liquid from the liquid discharge head 1 onto the medium-to-be-discharged P conveyed in the conveyance direction Y while moving the liquid discharge head 1 in the direction X. Note that the application of the present disclosure is not limited to the serial type ink jet discharge apparatus. The present disclosure can also be applied to a page wide type ink jet discharge apparatus that forms an image by discharging a liquid onto the medium-to-be-discharged P conveyed in the conveyance direction Y by using a line head (page-wide type head) that is elongated in the page width direction of the medium-to-be-discharged P. Note that in FIGS. 1A and 1B, a direction Z is the vertical direction. That is, the direction Z is a direction that intersects with (is orthogonal to, in this embodiment) an X-Y plane defined by the direction X and the conveyance direction Y.

The liquid discharge head 1 can discharge four types of ink, black (K), cyan (C), magenta (M) and yellow (Y). The liquid discharge head 1 can form a full-color image with the four types of ink. Note that the inks that can be discharged from the liquid discharge head 1 are not limited to the four types of ink described above. For example, the present disclosure can also be applied to a liquid discharge head 1 for discharging another kind of ink, such as spot color ink. That is, the types and number of inks discharged from the liquid discharge head 1 are not limited.

Next, differences between FIGS. 1A and 1B will be described. In FIG. 1A, the ink sub tank 54 is mounted on the liquid discharge head 1. Four ink supply tubes (liquid communication channels) 59 are attached to the ink sub tank 54. The liquid discharge apparatus 50 further includes a main ink tank 2 and an external pump 70. The main ink tank 2 stores ink. The ink stored in the main ink tank 2 is supplied to the ink sub tank 54 through the four ink supply tubes 59 under the driving force of the external pump 70. On the other hand, in FIG. 1B, the ink sub tank 54 is provided directly above the liquid discharge head 1. FIG. 1B differs from FIG. 1A in that the main ink tank 2 is not provided outside of the liquid discharge head 1, and therefore, the four ink supply tubes 59 are not attached, and the external pump 70 is not provided. Note that in both FIGS. 1A and 1B, the liquid discharge head 1 may be provided integrally with the ink sub tank 54 and may be configured so that the liquid discharge head 1 can be removably attached to the carriage 60. Alternatively, the ink sub tank 54 may be provided integrally with the carriage 60 and the ink sub tank 54 alone may be removably attached to the carriage 60. The following description will be made with reference to the configuration in FIG. 1A.

### <Basic Configuration of Liquid Discharge Head 1>

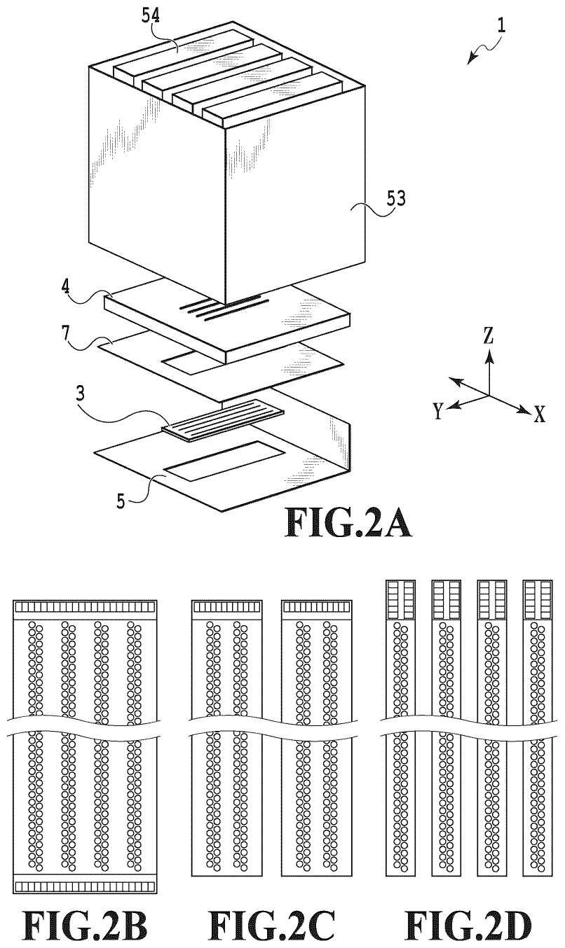

FIGS. 2A to 2D are diagrams showing examples of basic configurations of the liquid discharge head 1 in FIGS. 1A and 1B. FIG. 2A is an exploded perspective view of the liquid discharge head 1 in FIGS. 1A and 1B. FIGS. 2B, 2C and 2D are diagrams showing examples of a liquid discharge chip 3 in FIG. 2A. The liquid discharge head 1 includes a housing portion 53, the ink sub tank 54 and the liquid discharge chip 3. In the liquid discharge head 1, the ink sub tank 54 temporarily stores the ink. The ink sub tank 54 is housed in the housing portion 53. As described in detail later, the liquid discharge chip 3 is provided at a bottom part of the housing portion 53. The liquid discharge chip 3 discharges ink supplied from the ink sub tank 54 onto the medium-to-be-discharged P.

Although not shown in the drawing, a liquid connector insertion port is provided in a wall of the housing portion 53. A liquid connector provided at a tip end of the ink supply tube 59 in FIG. 1A is inserted into the liquid connector insertion port and connected thereto in a fluid tight manner. Configured in this way, an ink supply channel from the ink tank 2 to the liquid discharge head 1 via the external pump 70 is formed. In this embodiment, four types of ink are used. Therefore, a set of the ink tank 2, the external pump 70, the ink supply tube 59 and the ink sub tank 54 is provided for each of the four types of inks. Therefore, four ink supply channels corresponding to the respective inks are independently formed. In this embodiment, in this way, the liquid discharge apparatus 50 has an ink supply system in which inks are supplied from the ink tanks 2 provided outside of the liquid discharge head 1.

A first supporting member 4 and a second supporting member 7 are provided between the housing portion 53 and the liquid discharge chip 3. An electric wiring member 5 is provided below the liquid discharge chip 3. Specifically, an ink supply port and an ink collection port are provided in the first supporting member 4. An opening is provided in the second supporting member 7. The liquid discharge chip 3 is bonded and fixed to the first supporting member 4. The first supporting member 4 is bonded and fixed to the second supporting member 7. The second supporting member 7 holds the electric wiring member 5 in such a manner that the electric wiring member 5 is electrically connected to the liquid discharge chip 3. The electric wiring member 5 applies an electric signal for discharging ink or an electric signal for circulating ink to the liquid discharge chip 3.

Note that in this embodiment, the liquid discharge apparatus 50 does not include any ink collection system for collecting ink from the liquid discharge head 1 to the ink tank 2. Therefore, the ink tank 2 has no connector insertion port to which a tube for collecting ink is to be connected, although the liquid discharge head 1 has a liquid connector insertion port to which a liquid connector of the ink supply tube 59 is to be connected.

FIG. 2B is a diagram showing a case where one liquid discharge chip 3 is provided for four colors. That is, FIG. 2B shows a case where one liquid discharge chip 3 can discharge four colors of inks. The liquid discharge chip 3 includes a plurality of discharge orifices and a pad used for electrical implementation. The four colors are black, cyan, magenta and yellow, for example, and each color is assigned to a separate column. Each of the columns extend in the conveyance direction Y and are spaced apart from each other in the direction X. Each of the columns includes a plurality of discharge orifices. The plurality of discharge orifices are arranged at regular intervals in the Y direction. The discharge orifices in each column may be arranged in a line in the Y direction, rather than being spaced apart from each other in the X direction. Alternatively, only black color may be assigned to two columns, and the other three colors may be assigned to three columns, for a total of five columns of four colors. Note that in the example configuration shown in FIG. 2A, the liquid discharge chip 3 is one chip provided for four colors. That is, the liquid discharge chip 3 in FIG. 2A is the liquid discharge chip 3 shown in FIG. 2B.

FIG. 2C is a diagram showing a case where one liquid discharge chip 3 is provided for two colors. In this case, two chips are used. That is, FIG. 2C is a diagram showing a case where one liquid discharge chip 3 can discharge two colors of inks. Concerning mounting of the liquid discharge chips 3 in the liquid discharge head 1, two liquid discharge chips 3 capable of discharging two colors of inks may be mounted in one liquid discharge head 1, or as shown in FIG. 2D, two liquid discharge heads 1 each having one liquid discharge chip 3 capable of discharging one color of ink may be prepared.

FIG. 2D is a diagram showing a case where one liquid discharge chip 3 is provided for one color. In this case, four chips are used. That is, FIG. 2D is a diagram showing a case where one liquid discharge chip 3 can discharge one color of ink. Concerning mounting of the liquid discharge chips 3 in the liquid discharge head 1, four liquid discharge chips 3 capable of discharging one color of ink may be mounted in one liquid discharge head 1, or four liquid discharge heads 1 each having one liquid discharge chip 3 capable of discharging one color of ink may be prepared.

In the cases where a plurality of liquid discharge chips 3 are mounted in one liquid discharge head 1 as in the cases shown in FIGS. 2C and 2D, the liquid discharge chips 3 may have different chip lengths. Furthermore, the number of colors of the liquid discharge chip 3 is not particularly limited, and various combinations of colors are possible. For example, although FIG. 2A shows an example in which the number of colors of the liquid discharge chip 3 is four, the number of colors of the liquid discharge chip 3 may be greater than four.

### <Individual Flow Channel: Straight Type>

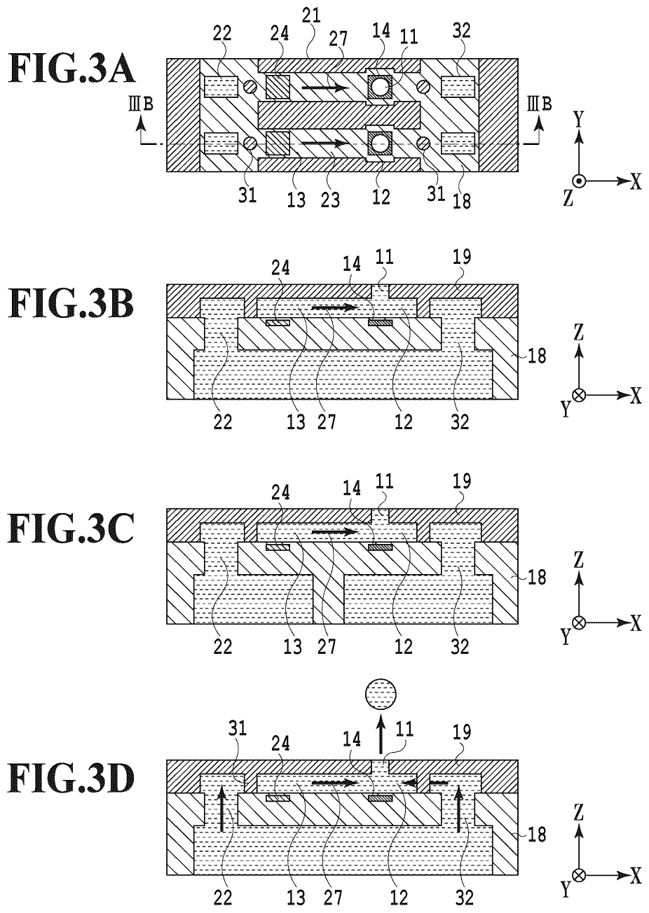

The liquid discharge head 1 includes a plurality of individual discharge units including individual flow channels. The liquid discharge head 1 also includes a supply flow channel for supplying a liquid to the individual flow channel of each individual discharge unit. FIGS. 3A to 3D are schematic diagrams illustrating a discharge orifice 11 of the individual discharge unit including a straight type individual flow channel 23 and its periphery. FIG. 3A is a plan view of the individual discharge unit viewed from a direction in which a droplet is discharged from the discharge orifice 11. FIG. 3B is a cross-sectional view taken along the line IIIb-IIIb in FIG. 3A. FIG. 3C is a cross-sectional view taken along the line IIIb-IIIb in FIG. 3A, in which the configuration in a substrate 18 is different from that shown in FIG. 3B.

The individual discharge unit includes the discharge orifice 11, a pressure chamber 12, a first energy generating element 14 (referred to also as a discharge energy generating element 14) and a second energy generating element 24 (referred to also as a circulation energy generating element 24).

The pressure chamber 12 is formed for each discharge orifice 11 by partitioning a space between the substrate 18 and an orifice plate 19 with a partition 21. The pressure chamber 12 can be filled with ink (referred to also as liquid). The discharge orifice 11 is an opening formed in a part of the orifice plate 19. In the discharge orifice 11, a meniscus of the ink flowed through the pressure chamber 12 is stretched to form a discharge orifice interface as an interface between the ink and the atmosphere. The discharge orifice 11 discharges the liquid.

In a second direction that intersects with (is orthogonal to, in this embodiment) the direction (first direction) in which the discharge orifices 11 are arranged in a line, the individual flow channel 23 extends. The individual flow channel 23 includes the pressure chamber 12, an inlet-side (upstream-side) connection flow channel 13 and an outlet-side (downstream-side) connection flow channel. The inlet-side connection flow channel 13 is in communication with one end part of the pressure chamber 12. The outlet-side connection flow channel is in communication with another end part of the pressure chamber 12.

A first supply opening 22 is provided on the side of one end of the individual flow channel 23. The first supply opening 22 is an opening that passes through the substrate 18 from a common flow channel (not shown) to the upstream side of the individual flow channel 23. A second supply opening 32 is provided on the side of another end of the individual flow channel 23. The second supply opening 32 is an opening that passes through the substrate 18 from the common flow channel (not shown) to the downstream side of the individual flow channel 23. The liquid is supplied to the individual flow channel 23 through the first supply opening 22 and the second supply opening 32.

In the substrate 18, the first energy generating element 14 is provided closer to the second supply opening 32 than to the first supply opening 22. The first energy generating element 14 is an element that generates energy for discharging the liquid in the pressure chamber 12 from the discharge orifice 11. Specifically, the first energy generating element 14 is driven to generate heat to make the liquid (referred to also as ink) in the pressure chamber 12 bubble, and the ink can be discharged from the discharge orifice 11 by the bubbling energy. Although the first energy generating element 14 used in this embodiment is an electrothermal conversion element, the first energy generating element 14 is not particularly limited. For example, a piezoelectric element may be used as the first energy generating element 14.

In the substrate 18, the second energy generating element 24 is provided closer to the first supply opening 22 than to the second supply opening 32. The second energy generating element 24 is an element that generates energy for producing a circulatory flow of the ink in the individual flow channel 23 in the direction indicated by the arrow 27. Although the second energy generating element 24 used in this embodiment is an electrothermal conversion element, the second energy generating element 24 is not particularly limited. For example, a piezoelectric element may be used as the second energy generating element 24.

Here, the straight type will be described. The straight type means that the opposite end parts of the individual flow channel 23 are located on the opposite sides of the discharge orifice 11, and the individual flow channel 23 is shaped so that the direction in which the opposite end parts of the individual flow channel 23 are arranged agrees with a direction that intersects with (is orthogonal to, in the example in FIG. 3) the direction of the line of the discharge orifices 11. In other words, the individual flow channel 23 is arranged in such a manner that the first energy generating element 14 and the second energy generating element 24 are arranged in the direction that intersects with the direction of the line of the discharge orifices 11.

Furthermore, the inlet-side connection flow channel 13 is formed on the side of the second energy generating element 24. The inlet-side connection flow channel 13 is formed by a part of the individual flow channel 23 that is closer to the second energy generating element 24 and the first supply opening 22. On the other hand, an outlet flow channel is formed on the side of the first energy generating element 14. The outlet flow channel is formed by another part of the individual flow channel 23 that is closer to the first energy generating element 14 and the second supply opening 32.

Next, a flow of the ink in the individual flow channel 23 will be described. The flow of the ink in the individual flow channel 23 is classified into two types. A first ink flow is a flow for refilling after the liquid discharge apparatus 50 drives the first energy generating element 14 to discharge the ink from the discharge orifice 11. A second ink flow is a circulatory flow produced in the direction indicated by the arrow 27 by the liquid discharge apparatus 50 driving the second energy generating element 24.

### <First Ink Flow>

FIG. 3D shows how the liquid discharge apparatus 50 drives the first energy generating element 14 to discharge ink from the discharge orifice 11. FIG. 3D is a diagram illustrating an inflow of ink into the pressure chamber 12 in the case where the first energy generating element 14 is driven. In the example in FIG. 3D, as ink is discharged from the discharge orifice 11, ink is supplied through each of the first supply opening 22 and the second supply opening 32. Therefore, ink flows into the pressure chamber 12 through both the first supply opening 22 and the second supply opening 32.

### <Second Ink Flow>

On the other hand, when the second energy generating element 24 is driven to produce a circulatory flow, ink flows into the individual flow channel 23 through the first supply opening 22 and flows out of the individual flow channel 23 through the second supply opening 32. In this embodiment, the liquid discharge apparatus 50 produces a circulatory flow of ink in the direction indicated by the arrow 27 in the individual flow channel 23 by feeding the ink flowing out through the second supply opening 32 back to the first supply opening 22. FIG. 3C shows an example in which the first supply opening 22 and the second supply opening 32 are provided as separate flow channels and are merged outside of the liquid discharge head 1 FIG. 3D shows an example in which the first supply opening 22 and the second supply opening 32 are merged in the liquid discharge chip 3.

The circulatory flow of ink will be further described. The ink contains a volatile constituent, such as water, and a solid constituent. During use of the liquid discharge head 1, the discharge of the ink through the discharge orifice 11 may become unstable due to evaporation of the volatile constituent of the ink through the discharge orifice 11 or concentration of the solid constituent of the ink in the vicinity of the discharge orifice 11 as a result of the evaporation of the volatile constituent of the ink, for example. To prevent the discharge of the ink through the discharge orifice 11 from becoming unstable, various measures are taken.

For example, a cap member (not shown) may be provided at a position offset from the conveyance channel of the discharged medium P in the X direction. The cap member is shaped to be able to cover a discharge orifice surface of the liquid discharge head 1 in which the discharge orifices 11 are provided. The cap member can prevent the discharge orifices 11 from drying or protect the discharge orifices 11 by covering the discharge orifice surface of the liquid discharge head 1 in which the discharge orifices 11 are provided when the liquid discharge head 1 is not performing the recording operation on the discharged medium P.

Furthermore, an ink suction mechanism (not shown) may be provided. In the case where the cap member and the ink suction mechanism are provided, the cap member is used in cooperation with an ink suction operation through the discharge orifices 11. The ink suction operation refreshes the ink in the vicinity of the discharge orifices 11, and therefore, the quality of the image formed can be maintained.

Furthermore, a concentrated ink can be discarded by performing a discharge operation referred to as preliminary discharge (referred to also as preliminary ejection) when the liquid discharge head 1 is not performing the recording operation on the discharged medium P. Furthermore, it is also known to perform a discharge operation referred to as preliminary discharge (referred to also as on-paper preliminary discharge or in-page preliminary discharge) when the liquid discharge head 1 is performing the recording operation on the discharged medium P. The on-paper preliminary discharge or in-page preliminary discharge is a discharge operation of discharging a small amount of ink at an inconspicuous position on the discharged medium P in terms of image quality. These discharge operations largely contribute to improvement of the image quality. However, some of the ink is discarded in order to refresh the discharge orifices 11. The amount of discarded ink is preferably minimized.

In this regard, the second energy generating element 24 that heats the ink in the individual flow channel 23 is provided in the substrate 18 to enable generation of a circulatory flow of the ink. By generating the circulatory flow of ink, the amount of discarded ink can be reduced, and drying of the discharge orifice 11 and concentration of the ink in the vicinity of the discharge orifice 11 can be prevented. From another viewpoint, the number of preliminary discharges of ink and the number of suctions of ink can be minimized. Furthermore, since the number of preliminary discharges of ink is minimized, the throughput and yield of the liquid discharge apparatus 50 as a whole can be improved. Note that the second energy generating element 24 can produce the effects described above if the second energy generating element 24 is provided for at least some of the plurality of individual flow channels 23 included in the liquid discharge head 1.

Furthermore, the liquid discharge head 1 in FIG. 1A may be configured with the second energy generating elements 24 provided at all positions for the four types of ink, or may be configured with the second energy generating element 24 provided at only a position for one type of ink. That is, the liquid discharge head 1 may be configured to circulate at least one of the plurality of types of ink.

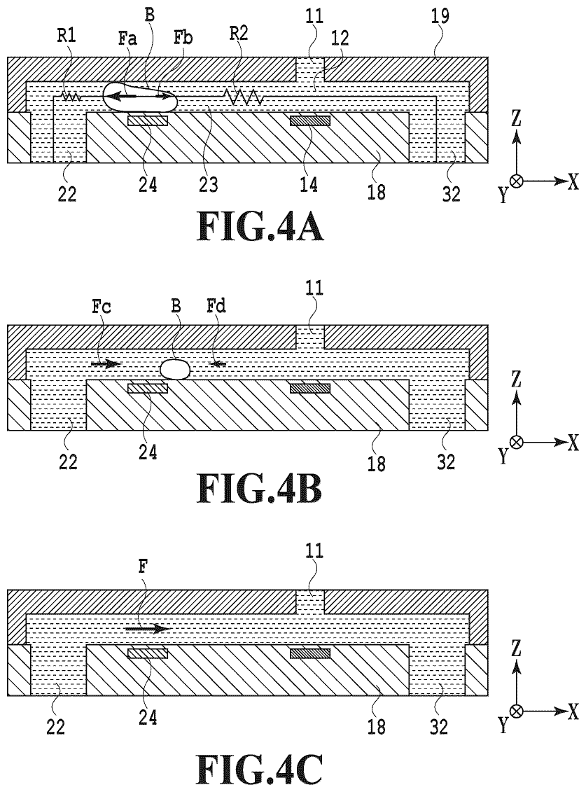

Note that a filter 31 shown in FIG. 3A may be provided in the circulation channel of the ink in order to remove a foreign matter in the ink. The filter 31 is a projection formed by projecting a part of the orifice plate 19 toward the substrate 18. In the example shown in FIGS. 3A to 3D, filters 31 are provided at a position on the side of one end of the individual flow channel 23 and a position on the side of the other end of the individual flow channel 23. In the circulation channel of the ink, the side of one end of the individual flow channel 23 corresponds to the flow-in side of the ink, and the side of the other end of the individual flow channel 23 corresponds to the flow-out side of the ink. The filter 31 may be provided between the first energy generating element 14 and the second energy generating element 24 in the individual flow channel 23. When the filter 31 is provided between the first energy generating element 14 and the second energy generating element 24 in the individual flow channel 23, the filters 31 at the position on the side of one end of the individual flow channel 23 and the position on the side of the other end of the individual flow channel 23 are not needed. Next, a principle of generation of the circulatory flow of ink will be described with reference to FIGS. 4A to 4C.

### <Principle of Generation of Circulatory Flow of Ink>

FIGS. 4A to 4C are diagrams illustrating a principle of generation of a circulatory flow of ink. For case of description, illustration of the filter 31 is omitted in FIGS. 4A to 4C. FIG. 4A is a cross-sectional view of the individual discharge unit taken along the line IIIb-IIIb in FIG. 3A for illustrating a generation and development process of a bubble B generated by film boiling of ink heated by the second energy generating element 24. FIG. 4B is a cross-sectional view of the individual discharge unit taken along the line IIIb-IIIb in FIG. 3A for illustrating a contraction process of the bubble B generated by film boiling of ink heated by the second energy generating element 24. FIG. 4C is a cross-sectional view of the individual discharge unit taken along the line IIIb-IIIb in FIG. 3A for illustrating a process after disappearance of the bubble B generated by film boiling of ink heated by the second energy generating element 24. Next, the generation and development process of the bubble B, the contraction process of the bubble B and the process after disappearance of the bubble B will be described.

### <Generation and Development Process of Bubble B>

As shown in FIG. 4A, the second energy generating element 24 is disposed at a position closer to the first supply opening 22 among the first supply opening 22 and the second supply opening 32. Since a circulatory flow of ink is generated, a flow resistance R1 that occurs in a flow channel between the second energy generating element 24 and the first supply opening 22 is smaller than a flow resistance R2 that occurs in a flow channel between the second energy generating element 24 and the second supply opening 32. Because of the difference between the flow resistance R1 and the flow resistance R2, the bubble B generated by film boiling of the ink is developed toward the flow channel having the smaller flow resistance R1, as shown in FIG. 4A. Therefore, a flow vector Fa of the ink toward the flow channel having the flow resistance R1 is greater than a flow vector Fb of the ink toward the flow channel having the flow resistance R2. Note that the circuit including the flow resistances R1 and R2 is an equivalent circuit that compares the flow resistances produced by the circulatory flow of ink in the flow channel including the individual flow channel 23 to electric resistances.

### <Contraction Process of Bubble B>

In the contraction process of the bubble B, ink flows to compensate for the reduction in volume of the contracting bubble B. In this process, as shown in FIG. 4B, a flow vector Fc of the ink flowing from the first supply opening 22 on the side of the flow channel having the flow resistance R1 is greater than a flow vector Fd of the ink flowing from the second supply opening 32 on the side of the flow channel having the flow resistance R2. Furthermore, the position where the bubble B disappears is shifted from the second energy generating element 24 toward the flow channel closer to the second supply opening 32.

<Process after Disappearance of Bubble B>

As described above with reference to FIG. 4B, there is a relation: Fc>Fd. Therefore, a flow vector F of the circulatory flow of ink from the first supply opening 22 toward the second supply opening 32 occurs. The magnitude of the flow vector F depends on the ratio between the flow resistances R1 and R2 and the size of the bubble B. For example, consider a case where the second energy generating element 24 is used. In this case, the position where the second energy generating element 24 is disposed is preferably closer to one of the opposite end parts of the individual flow channel 23 than the position where the first energy generating element 14 is disposed. Specifically, the position is preferably set in the range where the flow resistance ratio R1/R2 is 0.05 to 0.40. By setting the position in the range where the flow resistance ratio R1/R2 is 0.05 to 0.40, the flow vector F of the circulatory flow of ink can be maximized. By increasing the flow vector Fa of ink and increasing the flow vector Fc of ink, the flow vector F of the circulatory flow of ink increases, and the circulatory flow of ink increases. Therefore, the flow resistance R1 is preferably reduced. In addition, the flow vector Fb of ink is preferably minimized, and the flow vector Fd of ink is preferably reduced. Therefore, the flow resistance R2 is preferably increased. In short, the flow resistance R1 is preferably reduced, and the flow resistance R2 is preferably increased. That is, the flow resistance ratio R1/R2 is preferably reduced. Furthermore, if the bubble B is large, that is, the bubble B has a large volume, it means that the displacement volume of the fluid in the individual flow channel 23 increases, and therefore, the circulatory flow also increases. For example, factors contributing to the increase of the circulatory flow are as follows. A factor contributing to the increase of the circulatory flow is increasing the size of the second energy generating element 24. Another factor contributing to the increase of the circulatory flow is increasing the width or height of the flow channel on the side of the first supply opening 22 to relatively reduce the flow resistance R1. Another factor contributing to the increase of the circulatory flow is reducing the viscosity of the ink. Another factor contributing to the increase of the circulatory flow is raising the temperature of the liquid discharge head 1. Another factor contributing to the increase of the circulatory flow is doubling the drive pulse. Pulse-doubling of the drive pulse means as follows. First, a short pulse that does not cause a bubble in the flow channel above the second energy generating element 24 is applied to the second energy generating element 24 to heat the ink in the flow channel near the second energy generating element 24. Then, a main pulse that causes a bubble that makes the ink circulate is applied to the second energy generating element 24 to make a larger bubble develop. Specifically, the first pulse causes the ink to be heated to close to the boiling point in the widest possible range around the heater, and the second pulse causes rapid vaporization of the ink in the wide range. In this way, the bubble becomes large. That is, by inputting two pulses, the volume of the bubble increases.

Furthermore, the circulatory flow of ink partially flows into the discharge orifice 11. As a result, any concentrated ink in the discharge orifice 11 is pushed to the flow channel on the side of the second supply opening 32, and fresh ink is fed into the discharge orifice 11 from the flow channel on the side of the first supply opening 22 through the individual flow channel 23. In this way, the concentrated ink is less likely to stagnate in the discharge orifice 11. Therefore, the influence of the concentrated ink can be reduced, and the initial ink discharge state can be maintained.

The circulatory flow of ink is a transient flow in the generation and development process and the contraction process of the bubble B. Therefore, after the bubble B disappears, the inertial circulatory flow of ink attenuates with time and stops after a certain time. Therefore, in order to steadily generate a circulatory flow for a certain time, the second energy generating element 24 is preferably repeatedly driven. Note that the driving cycle of the second energy generating element 24 is not particularly limited as far as the concentrated ink stagnating in the discharge orifice 11 can be discharged. However, the circulatory flow of ink is a transient flow in the generation and development process and the contraction process of the bubble B. Therefore, when a cycle of 10 μs (microsecond), which is the duration of the bubble B from generation to disappearance, is considered and the second energy generating element 24 is driven at a high driving frequency, such as 100 kHz (kilohertz), a phenomenon that inhibits promotion of the circulatory flow of ink may occur. Therefore, the second energy generating element 24 is preferably driven with a driving cycle of 100 Hz to several tens of kHz, for example.

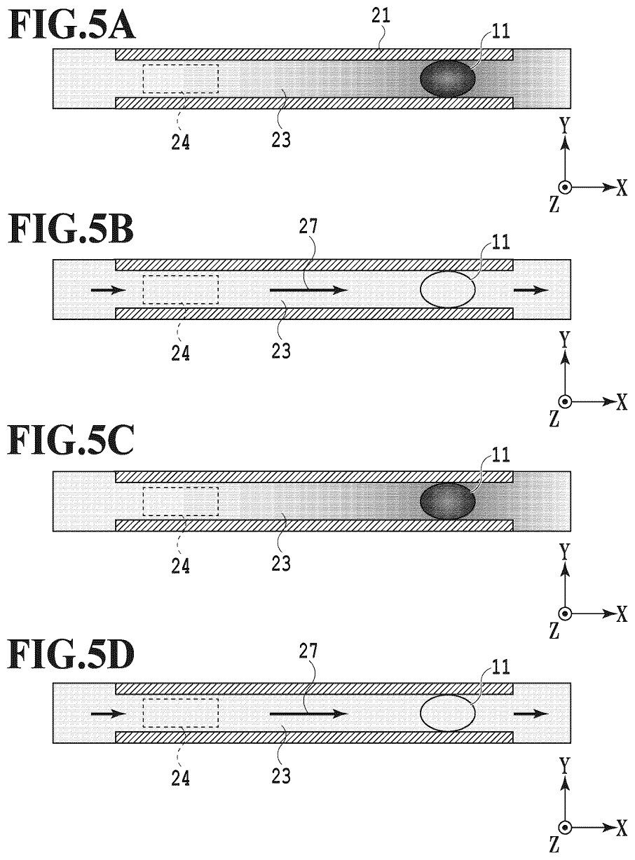

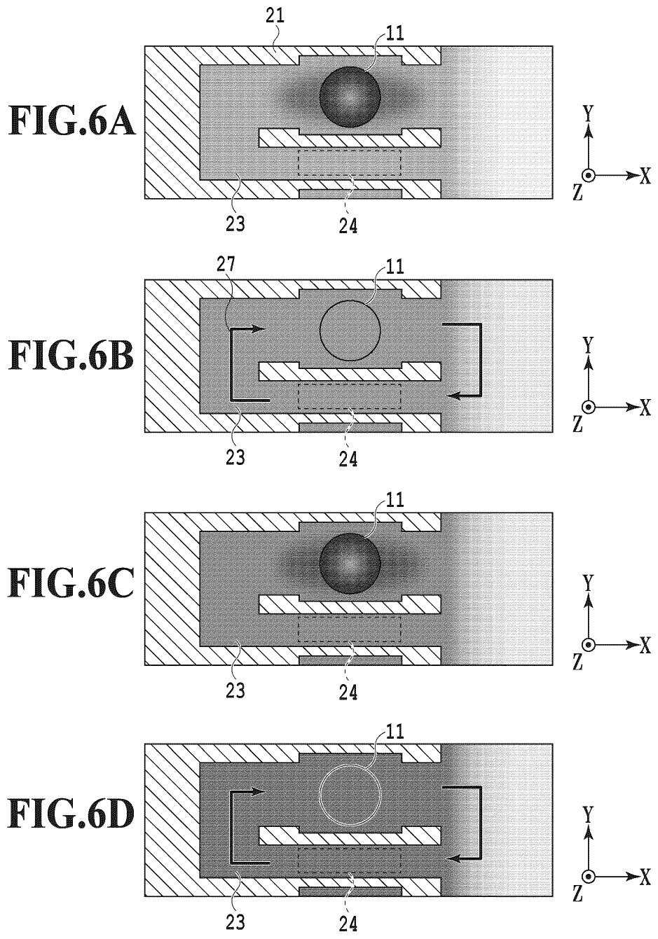

Specifically, as the driving frequency of the second energy generating element 24 becomes higher, the circulatory flow of ink is more likely to be maintained, so that the effect of the circulatory flow of ink to discharge the concentrated ink grows. However, as the driving frequency of the second energy generating element 24 becomes higher, the temperature of the ink is expected to be raised due to heat generation of the second energy generating element 24 caused by driving of the second energy generating element 24. Therefore, the number of times of driving of the second energy generating element 24 is preferably appropriately controlled. Next, elimination of concentration of ink by the circulatory flow of ink will be described with reference to FIGS. 5A to 5D and 6A to 6D.

### <Elimination of Concentration of Ink: Straight Type>

FIGS. 5A to 5D are diagrams illustrating how concentration of ink is eliminated by a circulatory flow of ink in the straight type individual flow channel 23. FIG. 5A is a diagram showing a state where the circulatory flow of ink is temporarily stopped. FIG. 5B is a diagram showing a state immediately after the circulatory flow of ink is produced by driving the second energy generating element 24 after the state shown in FIG. 5A. FIG. 5C is a diagram showing a state where the circulatory flow of ink is temporarily stopped after the state shown in FIG. 5B. FIG. 5D is a diagram showing a state immediately after the circulatory flow of ink is produced by driving the second energy generating element 24 after the state shown in FIG. 5C. As shown in FIGS. 5A to 5D, the straight type individual flow channel 23 is configured with separate inlet and outlet for the circulatory flow of ink. Note that the ink in the individual flow channel 23 is indicated by dot hatching, and the concentrated ink is indicated by denser dot hatching to indicate the degree of concentration of the ink.

As shown in FIG. 5A, in the state where the circulatory flow of ink is temporarily stopped, the volatile constituent of the ink evaporates through the discharge orifice 11. Therefore, concentration of the ink proceeds in the vicinity of the discharge orifice 11. After that, when the second energy generating element 24 is driven, the circulatory flow of ink is resumed. As a result, as shown in FIG. 5B, the concentration of ink having proceeded in the vicinity of the discharge orifice 11 is eliminated. After that, when the circulatory flow of ink is temporarily stopped, as in FIG. 5A, concentration of the ink proceeds again in the vicinity of the discharge orifice 11 as shown in FIG. 5C. After that, when the second energy generating element 24 is driven, the circulatory flow of ink is resumed. As a result, as in FIG. 5B, the concentration of ink having proceeded in the vicinity of the discharge orifice 11 is eliminated as shown in FIG. 5D. Therefore, concentration of ink is eliminated in the entire individual flow channel 23. In the straight type individual flow channel 23, the concentrated state of ink is cleared each time the temporary stop and resuming of the circulatory flow of ink is repeated as described above.

### <Elimination of Concentration of Ink: U-type>

FIGS. 6A to 6D are diagrams illustrating how concentration of ink is eliminated by a circulatory flow of ink in a U-type individual flow channel 23. FIG. 6A is a diagram showing a state where the circulatory flow of ink is temporarily stopped. FIG. 6B is a diagram showing a state immediately after the circulatory flow of ink is produced by driving the second energy generating element 24 after the state shown in FIG. 6A. FIG. 6C is a diagram showing a state where the circulatory flow of ink is temporarily stopped after the state shown in FIG. 6B. FIG. 6D is a diagram showing a state immediately after the circulatory flow of ink is produced by driving the second energy generating element 24 after the state shown in FIG. 6C. As shown in FIGS. 6A to 6D, the U-type individual flow channel 23 is configured with adjacent inlet and outlet for the circulatory flow of ink. Note that the ink in the individual flow channel 23 is indicated by dot hatching, and the concentrated ink is indicated by denser dot hatching to indicate the degree of concentration of the ink.

As shown in FIG. 6A, in the state where the circulatory flow of ink is temporarily stopped, the volatile constituent of the ink evaporates through the discharge orifice 11. Therefore, concentration of the ink proceeds in the vicinity of the discharge orifice 11. After that, when the second energy generating element 24 is driven, the circulatory flow of ink is resumed. As a result, the state shown in FIG. 6B arises. The inlet of the individual flow channel 23 in FIG. 6A is adjacent to the outlet of the individual flow channel 23 in FIG. 6A. Therefore, although the ink concentrated in the vicinity of the discharge orifice 11 is discharged through the outlet of the individual flow channel 23, part of the discharged ink flows into the individual flow channel 23 again through the inlet. Therefore, the ink in the individual flow channel 23 is not totally replaced with fresh ink, and a phenomenon where the ink in the individual flow channel 23 is replaced with slightly concentrated ink (this phenomenon will be referred to as recirculation concentration) occurs. After that, when the circulatory flow of ink is temporarily stopped, as in FIG. 6A, concentration of the ink proceeds again from the state shown in FIG. 6B in the vicinity of the discharge orifice 11 as shown in FIG. 6C. After that, when the second energy generating element 24 is driven, the circulatory flow of ink is resumed. As a result, as shown in FIG. 6D, the ink in the whole of the individual flow channel 23 is replaced with more concentrated ink than that in FIG. 6B because of the recirculation concentration. In the U-type individual flow channel 23, the concentrated state of ink is not cleared each time the temporary stop and resuming of the circulatory flow of ink is repeated as described above, and concentration of ink in the whole of the individual flow channel 23 gradually proceeds. Therefore, the concentrated state of ink becomes worse. Note that not only when the temporary stop and resuming of the circulatory flow of ink are not repeated but also when the temporary stop of the circulatory flow of ink is elongated, if concentration of ink in the vicinity of the discharge orifice 11 has proceeded, it is difficult to achieve the effect of improving the concentrated state of ink even when the circulatory flow of ink is resumed for the first time. This is because the effect of improving the concentrated state of ink is reduced by the recirculation concentration.

Therefore, the straight type individual flow channel 23 and the U-type individual flow channel 23 differ in effect of eliminating the concentrated state of ink by temporarily stopping and resuming the circulatory flow of ink, due to the influence of the concentrated ink discharged. Specifically, in the case of the straight type individual flow channel 23, the concentrated state of the ink in the whole of the individual flow channel 23 is more likely to be eliminated. On the other hand, in the case of the U-type individual flow channel 23, the concentrated state of the ink in the whole of the individual flow channel 23 is less likely to be eliminated because of the recirculation concentration. Therefore, in the case of the U-type individual flow channel 23, discharge of the ink may become unstable depending on the degree of concentration of the ink in the whole of the individual flow channel 23.

### <Ink>

As described above, although the degree of elimination of concentration of ink varies with the flow channel arrangement including the individual flow channel 23, the following effect can be achieved by producing a circulatory flow of ink in the individual flow channel 23 using the second energy generating element 24 capable of serving as a circulating heater. That is, the influence of the concentrated ink increased in viscosity as a result of evaporation of the volatile constituent of the ink through the discharge orifice 11 can be reduced. Therefore, an excellent state of discharge of the ink can be maintained, and the influence of the variation of the discharge rate of the ink can be further reduced. Therefore, the discharge of the ink can be stabilized.

On the other hand, depending on the application of the liquid discharge head 1 or the liquid discharge apparatus 50 provided with the liquid discharge head 1, inks containing different color materials or having different contents of solid constituents may be used. With regard to the performance of the liquid discharge head 1, the ink discharge stability is preferably maintained regardless of the type of the ink.

For example, as a problem stemming from water in the ink, a distortion such as curling (referred to as warping) or cockling (referred to also as waving creases) may occur on plain paper. In such a case, an ink reduced in water content can be used. The ink reduced in water content has a higher concentration of an organic solvent other than water, a pigment or a solid constituent, such as resin, of the ink. Therefore, as the water in the ink evaporates, the viscosity of the ink tends to rapidly increase. Therefore, the ink reduced in water content is more likely to decrease in ink discharge stability. In this regard, when the ink reduced in water content is used, the increase in viscosity of the ink can be reduced by producing a circulatory flow of the ink in the flow channel arrangement including the individual flow channel 23 as in this embodiment. In general, an ink having a high content of solid constituents contains 10 wt % of solid constituents. Thus, this embodiment is preferably applied to inks containing 10 wt % (weight percent and referred to also as % by mass) or more of solid constituents.

A relationship between the operating temperature of the liquid discharge head 1 and the viscosity of the ink will be described. The liquid discharge head 1 may be used by heating the liquid discharge head until the temperature of the liquid discharge head 1 reaches a certain temperature by driving and controlling the second energy generating elements 24 arranged across the liquid discharge chip 3. The viscosity of the ink varies with the temperature of the ink. Therefore, the viscosity of the ink at the operating temperature of the liquid discharge head 1 affects the ink discharge stability.

A relationship between the circulation flow velocity of the ink and the driving frequency of each of the first energy generating element 14 and the second energy generating element 24 will be described. When the second energy generating element 24 capable of serving as a circulating heater is used to produce a circulatory flow of ink, a circulation flow velocity can be achieved at which the instantaneous flow velocity of ink is several tens of mm/s to 1000 mm/s. The average flow velocity in a time span of the order of several hundreds of us depends on the driving frequency of the second energy generating element 24. This is because when the second energy generating element 24 is used to produce a circulatory flow of ink, the circulatory flow of ink is a transient circulatory flow that attenuates with time and stops after a certain time. However, the second energy generating element 24 can be driven at a frequency of about 10 to 20 kHz, which is approximately equal to the driving frequency (referred to also as a discharge frequency) of the first energy generating element 14 capable of serving as a discharging heater. In this case, the average flow velocity of the circulatory flow of ink can be several mm/s to 100 mm/s. Next, a relationship between the pigment concentration and the elimination of concentration of ink will be described.

### (Ink Having High Pigment Concentration)

A case of an ink having a high pigment concentration will be described. For example, when an ink having such a concentration that the viscosity of the ink at the operating temperature of the liquid discharge head 1 is equal to or higher than 3 cP and equal to or lower than 6 cP is used, thickening of the ink is likely to proceed in the vicinity of the discharge orifice 11 according to the non-discharge period of the ink (referred to as a pause period of the circulatory flow of the ink). Therefore, the ink discharge velocity is likely to change. Therefore, the ink discharge stability is likely to decrease. To reduce the decrease of the ink discharge stability, the circulatory flow of the ink is preferably produced to circulate the ink after a short pause period of the circulatory flow of the ink. Therefore, concentration of the ink is preferably eliminated by steadily circulating the ink or producing a transient circulation of the ink at high frequency. In this regard, the transient circulation of the ink can be produced by driving the second energy generating element 24. Performing a process of pausing the circulatory flow of the ink and resuming of the circulatory flow of the ink by driving the second energy generating element 24 at high frequency can contribute to eliminating concentration of the ink in the vicinity of the discharge orifice 11.

### (Ink Having Low Pigment Concentration)

A case of an ink having a low pigment concentration will be described. For example, when an ink having such a concentration that the viscosity of the ink at the operating temperature of the liquid discharge head 1 is equal to or higher than 1 cP and equal to or lower than 2 cP is used, thickening of the ink may proceed in the vicinity of the discharge orifice 11 according to the non-discharge period of the ink (referred to as a pause period of the circulatory flow of the ink). Therefore, the ink discharge velocity may change. However, compared with the ink having high concentration, the change of the ink discharge velocity is relatively small. However, if the pause period of the circulatory flow of the ink is elongated, for example, thickening of the ink in the vicinity of the discharge orifice 11 can proceed according to the non-printing/driving period (referred to as a halt period). Therefore, when restarting the liquid discharge apparatus after a certain halt period in which the liquid discharge apparatus is not used for printing, a recovery process that involves waste ink is preferably performed, such as an ink suction operation, a wiping operation or a preliminary discharge operation including the combination thereof. However, if the second energy generating element 24 is driven to resume the circulatory flow of the ink, this operation can serve as the recovery operation and contribute to eliminating concentration of the ink in the vicinity of the discharge orifice 11 without waste ink. Furthermore, depending on the halt period, the recovery operation may be achieved without waste ink simply by driving the second energy generating element 24 to resume the circulatory flow of the ink. Alternatively, a recovery operation that minimizes waste ink may be performed by combining the resuming of the circulatory flow of the ink for recovery and a suction operation for removing the bubble B in the liquid discharge head 1 that is a different operation than the suction operation for eliminating concentration of the ink.

### (Configuration More Suitable for Elimination of Concentration of Ink)

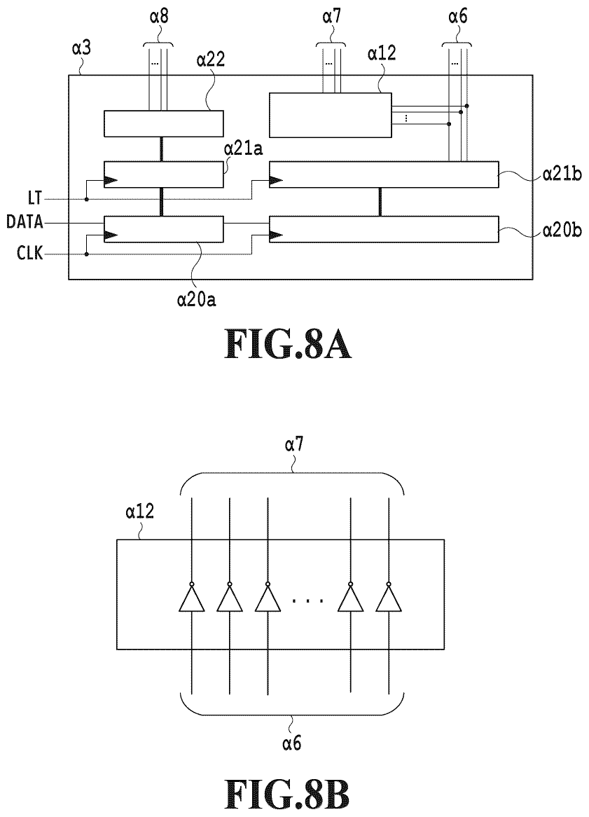

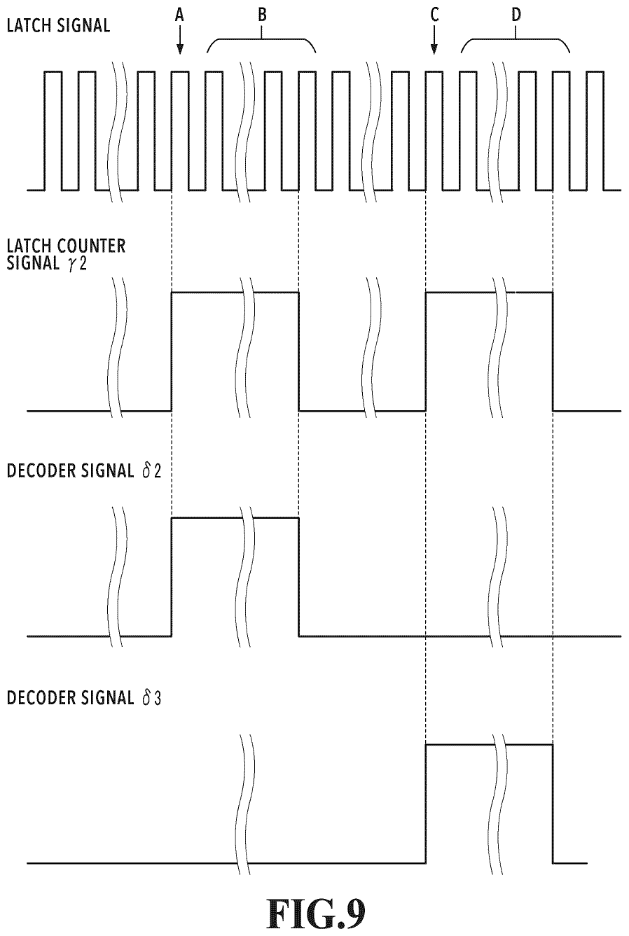

As described above, whether the ink has high concentration or low concentration, the ink is preferably recovered to the initial fresh state as far as possible in order to reduce the influence of the concentrated ink. In the case where the second energy generating element 24 is driven to this end, a higher circulation effect can be achieved as the effect of the recirculation concentration decreases. That is, a higher circulation effect can be achieved in the straight type individual flow channel 23 than in the U-type individual flow channel 23. Next, an electrical circuit configuration for driving and controlling the first energy generating element 14 and the second energy generating element 24 according to this embodiment will be described with reference to FIGS. 8A, 8B, and 9.

### (Discharge Element Substrate α0)

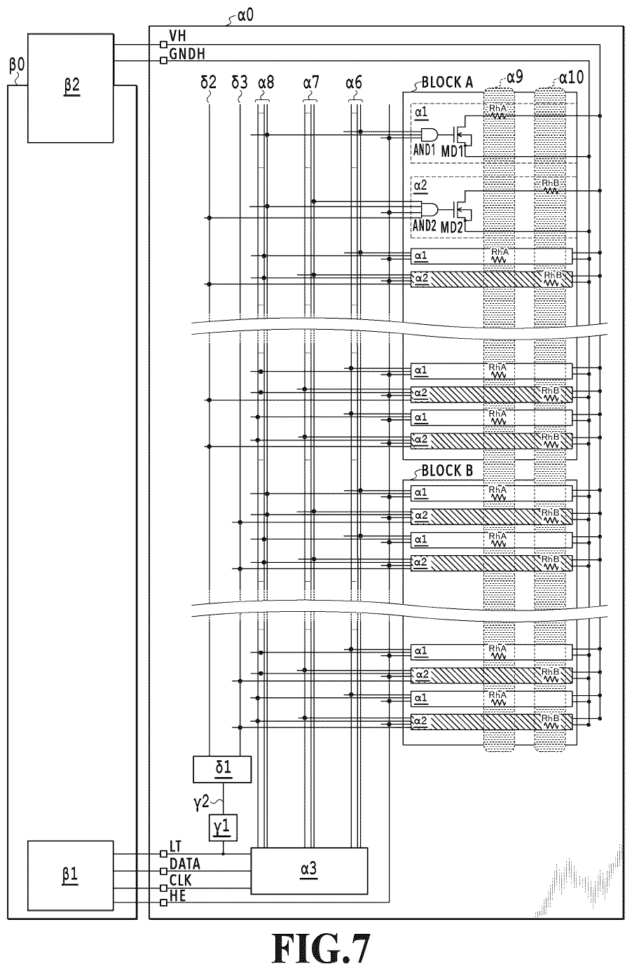

FIG. 7 is a diagram showing an example circuit configuration of a discharge element substrate α0 of the liquid discharge chip 3 in FIGS. 2A to 2D. FIGS. 8A and 8B are diagrams showing an example circuit configuration of a control data supply circuit α3 in FIG. 7. FIG. 8A is a functional block diagram of the circuit configuration of the control data supply circuit α3. Various signals are supplied to the discharge element substrate α0 from a main substrate β0. The main substrate β0 includes a controller 1 and a power supply circuit β2. The controller β1 mainly includes a ROM, a RAM and a CPU and supplies various electrical signals to the discharge element substrate α0 to control the liquid discharge head 1. The controller 1 supplies an enable signal HE, a latch signal LT, a data signal DATA and a clock signal CLK to the discharge element substrate α0. The signals will be described in detail later. The power supply circuit β2 applies a power supply voltage VH to the discharge element substrate α0. The power supply circuit β2 and the discharge element substrate α0 are connected to each other at GNDH. GNDH serves as a ground potential.

### (Overview of Wiring)

The discharge element substrate α0 includes a plurality of discharging modules α1, a plurality of circulating modules α2 and the control data supply circuit α3. The circulating module α2 is arranged in pair with the discharging module α1. Therefore, the number of the circulating modules α2 is equal to the number of the discharging modules α1. Between the plurality of discharging module α1 and the control data supply circuit α3, discharging group selection signal wiring α6 and common time-division selection signal wiring α8 are provided. Between the plurality of circulating module α2 and the control data supply circuit α3, circulating group selection signal wiring α7, the common time-division selection signal wiring α8 and latch counter signal wiring γ2 are provided.

Note that in this embodiment, the plurality of discharging modules α1 and the plurality of circulating modules α2 are further divided into a block A and a block B. Among the plurality of discharging modules α1 and the plurality of circulating modules α2, a first number of discharging modules α1 and the first number of circulating modules α2 are allocated to the block A. Among the plurality of discharging modules α1 and the plurality of circulating modules α2, a second number of discharging modules α1 and the second number of circulating modules α2 are allocated to the block B. The block A and the block B are set in different placement areas. That is, a first set of discharging modules among the plurality of discharging modules α1 and a first set of circulating modules among the plurality of circulating modules α2 are allocated to the block A. The first set of discharging modules include the first number of discharging modules α1. The first set of circulating modules include the first number of circulating modules α2. A second set of discharging modules among the plurality of discharging modules α1 and a second set of circulating modules among the plurality of circulating modules α2 are allocated to the block B. The second set of discharging modules include the second number of discharging modules α1. The second set of circulating modules include the second number of circulating modules α2. Therefore, the first set of discharging modules and the first set of circulating modules are arranged in the same placement area, the block A. The second set of discharging modules and the second set of circulating modules are arranged in the same placement area, the block B. Therefore, the first set of discharging modules and the second set of discharging modules are arranged in different placement areas. The first set of circulating modules and the second set of circulating modules are also arranged in different placement areas.

As a circuit for selecting any of the block A and the block B, the latch counter signal wiring γ2 is provided with a decoder circuit δ1. As described in detail later, decoder signal wiring δ2 and decoder signal wiring δ3 are provided on the output side of the decoder circuit δ1. The decoder signal wiring δ2 is connected to the circulating modules α2 in the block A. The decoder signal wiring δ3 is connected to the circulating modules α2 in the block B.

### (Discharging Module α1)

The discharging module α1 includes a discharging heater RhA, a discharging drive element MD1 and a discharging logic circuit AND1. The discharging heater RhA is formed by an electrothermal conversion element, for example. The discharging heater RhA is in the state where the power supply voltage VH is applied to the discharging heater RhA, and when the discharging drive element MD1 is conductive, a current flows through the discharging heater RhA. The discharging drive element MD1 is formed by a metal-oxide-semiconductor field effect transistor (MOSFET), for example. Note that the discharging drive element MD1 need not be formed by a MOSFET. For example, the discharging drive element MD1 may be formed by a bipolar transistor. Alternatively, the discharging drive element MD1 may be formed by an insulated gate bipolar transistor (IGBT). The discharging logic circuit AND1 selectively drives the discharging drive element MD1. The enable signal HE, the discharging group selection signal and the common time-division selection signal are input to the input side of the discharging logic circuit AND1. The enable signal HE is transmitted from the controller β1. The enable signal HE controls the current pulse width of the discharging drive element MD1, that is, the period for which the drain and source of the discharging drive element MD1 are conductive and a current is kept flowing between the drain and source of the discharging drive element MD1. The enable signal HE is a signal for adjusting the current pulse width so that a desired amount of thermal energy can be generated by considering various manufacturing variations. The various manufacturing variations include manufacturing variations of the resistance value of the discharging heater RhA mounted on the discharge element substrate α0 and manufacturing variations of the power supply circuit β2, for example. The various manufacturing variations further include a voltage drop on power supply-side wiring in the case where a plurality of heaters, such as the discharging heater RhA and a circulating heater RhB, are simultaneously driven. Note that the heaters simultaneously driven here are the discharging heater RhA and a circulating heater RhB that is not arranged in pair with the discharging heater RhA. The enable signal HE can be transmitted from the controller β1 through an external input terminal (not shown) provided on the discharge element substrate α0. The discharging group selection signal is supplied on the discharging group selection signal wiring α6. The common time-division selection signal is supplied on the common time-division selection signal wiring α8. The output side of the discharging logic circuit AND1 is connected to the gate of the discharging drive element MD1. Therefore, when all the signals input to the input side of the discharging logic circuit AND1 are 1, a voltage is applied to the gate of the discharging drive element MD1, and the drain and source of the discharging drive element MD1 are conductive. When the drain and source of the discharging drive element MD1 are conductive, a current flows through the discharging heater RhA, so that the discharging heater RhA generates heat. Through this series of operations, the ink can be bubbled and discharged onto the discharged medium P. Although an example has been described in which the discharging heater RhA is formed by an electrothermal conversion element, this is not intended to be limiting. For example, the discharging heater RhA may be formed by a piezoelectric element.

### (Circulating Module α2)

The circulating module α2 includes a circulating heater RhB, a circulating drive element MD2 and a circulating logic circuit AND2. The circulating heater RhB is formed by an electrothermal conversion element, for example. The circulating heater RhB is in the state where the power supply voltage VH is applied to the circulating heater RhB, and when the circulating drive element MD2 is conductive, a current flows through the circulating heater RhB. The circulating drive element MD2 is formed by a metal-oxide-semiconductor field effect transistor (MOSFET), for example. Note that the circulating drive element MD2 need not be formed by a MOSFET. For example, the circulating drive element MD2 may be formed by a bipolar transistor. Alternatively, the circulating drive element MD2 may be formed by an insulated gate bipolar transistor (IGBT). The circulating logic circuit AND2 selectively drives the circulating drive element MD2. The enable signal HE, the circulating group selection signal and a latch counter signal are input to the input side of the circulating logic circuit AND2. The latch counter signal is a signal obtained by counting edges of latch signals LT. A process using the latch counter signal will be described in detail later. The enable signal HE is transmitted from the controller β1. The enable signal HE controls the current pulse width of the circulating drive element MD2, that is, the period for which the drain and source of the circulating drive element MD2 are conductive and a current is kept flowing between the drain and source of the circulating drive element MD2. The enable signal HE is a signal for adjusting the current pulse width so that a desired amount of thermal energy can be generated by considering various manufacturing variations. The various manufacturing variations include manufacturing variations of the resistance value of the circulating heater RhB mounted on the discharge element substrate α0 and manufacturing variations of the power supply circuit β2, for example. The various manufacturing variations further include a voltage drop on power supply-side wiring at the time when a plurality of heaters, such as the circulating heater RhB and the discharging heater RhA, are simultaneously driven. Note that the enable signal HE can be transmitted from the controller β1 through an external input terminal (not shown) provided on the discharge element substrate α0. The circulating group selection signal is supplied on the circulating group selection signal wiring α7. The latch counter signal is supplied on the latch counter signal wiring γ2. The output side of the circulating logic circuit AND2 is connected to the gate of the circulating drive element MD2. Therefore, when all the signals input to the input side of the circulating logic circuit AND2 are 1, a voltage is applied to the gate of the circulating drive element MD2, and the drain and source of the circulating drive element MD2 are conductive. When the drain and source of the circulating drive element MD2 are conductive, a current flows through the circulating heater RhB, so that the circulating heater RhB generates heat. Through this series of operations, a bubble in the ink can be developed, and a circulatory flow can be produced in the ink circulation channel. Although an example has been described in which the circulating heater RhB is formed by an electrothermal conversion element, this is not intended to be limiting. For example, the circulating heater RhB may be formed by a piezoelectric element.

Note that concerning the enable signal HE described above, one enable signal HE is shared between discharge and circulation, in order to reduce the number of signal terminals. Therefore, the current pulse width cannot be separately controlled for discharge and circulation. Thus, the current pulse width may be adjusted with one enable signal HE on the assumption that the discharging heater RhA and the circulating heater RhB are manufactured in the same semiconductor step in a semiconductor manufacturing process and finished with the same manufacturing variations (the same offset of the resistance value from an ideal value). Alternatively, the current pulse width may be adjusted with one enable signal HE on the assumption that the discharging heater RhA and the circulating heater RhB are made of the same material and finished with the same manufacturing variations (the same offset of the resistance value from an ideal value).

Furthermore, a decoder signal is input to the input side of the circulating logic circuits AND2 in the block A via the decoder signal wiring δ2. When all the signals input to the input side of the circulating logic circuit AND2 are 1, a voltage is applied to the gate of the circulating drive element MD2. Therefore, the decoder signal input via the decoder signal wiring δ2 is a signal that triggers selection of a circulating module α2 in the block A.

Furthermore, the decoder signal is input to the input side of the circulating logic circuits AND2 in the block B via the decoder signal wiring δ3. When all the signals input to the input side of the circulating logic circuit AND2 are 1, a voltage is applied to the gate of the circulating drive element MD2. Therefore, the decoder signal input via the decoder signal wiring δ3 is a signal that triggers selection of a circulating module α2 in the block B.

Note that when there is only one of the block A and the block B, the decoder signal wiring δ2, the decoder signal wiring δ3 and the decoder circuit δ1 are unnecessary. Alternatively, when the plurality of discharging modules α1 and the plurality of circulating modules α2 are not divided into the block A and the block B, the decoder signal wiring δ2, the decoder signal wiring δ3 and the decoder circuit δ1 are unnecessary.

### (Control Data Supply Circuit α3)

The control data supply circuit α3 includes shift registers α20a and α20b, latch circuits α21a and α21b, a decoder circuit α22 and a circulating group control circuit α12. The control data supply circuit α3 is further provided with an external input terminal. The clock signal CLK, the data signal DATA and the latch signal LT are supplied from the controller β1 to the control data supply circuit α3 via the external input terminal. The clock signal CLK is a signal used for serial data transfer of the data signal DATA to the shift registers α20a and α20b. The data signal DATA includes selection information about the discharging module α1 and selection information about the circulating module α2. The latch signal LT obtains and holds information stored in each of the shift registers α20a and α20b at every latch cycle. The decoder circuit α22 and the circulating group control circuit α12 will be described in detail later.

### (Driving and Control of Discharging Heater RhA)

Driving and control of the discharging heater RhA in a discharging heater array α9 will be described. The discharging heater array α9 is formed by m groups. Each group includes n discharging heaters RhA. The discharging heater RhA is disposed directly below the discharge orifice of the ink. When one group is selected, the n discharging heaters RhA in the one group are sequentially activated in a time division manner. Driving and control of n (=16)×m (=40 groups) discharging heaters RhA arranged with a density of 600 dpi (dots per inch) will be described.

### (Time Division Control in One Group)

The discharging heater RhA is included in each discharging module α1. One group includes n discharging heaters RhA. Therefore, one group includes n discharging modules α1. Since n=16 is assumed, 16 discharging modules α1 are driven in a time division manner by a time-division selection signal. Time-division driving is a control of dividing the period of one discharge cycle into n (=16) unit times and sequentially selecting one of the discharging modules α1 every unit time. Here, in the same group, a plurality of discharging modules α1 are not selected at the same time. Every discharging module α1 included in the same group may be selected once in one discharge cycle. In such time-division driving, only one wire of the common time-division selection signal wiring α8 is selected. Therefore, by including the decoder circuit α22 in the control data supply circuit α3, the amount of data serially transferred from the main substrate β0 can be further reduced.

### (Decoder Circuit α22: Time-Division Control)

The decoder circuit α22 is a circuit that expands the number of bits of output data from the number of bits q of input data to the q-th power of 2. Specifically, when 4-bit input data is input to the decoder circuit α22, the decoder circuit α22 converts the 4-bit input data into 16-bit (16 is the fourth power of 2) output data. In this process, the output data from the decoder circuit α22 is output as information with only 1 bit of the 16 bits being valid. This allows the time-division driving. Here, all the wires of the common time-division selection signal wiring α8 used for output from the decoder circuit α22 are preferably used as a transmission medium for the common time-division selection signals unless the common time-division selection signal wiring α8 is used for a special purpose, from the viewpoint of utilization of input data. Note that the 4-bit input data may be derived from the bit configuration of the latch counter signal described later, for example. The bit configuration is a 4-bit configuration as shown in Table 1 described later. In addition, as the amount of data serially transferred increases, higher serial transfer is needed, and therefore, the cost and size of the signal transmission circuit, the signal receiving circuit and the transmission lines of the main substrate β0 and the discharge element substrate α0 increase. Therefore, the amount of data is preferably minimized.

### (Selective Control of Group)

To selectively drive any of the m groups, an m-bit discharging group selection signal is output from the control data supply circuit α3. When one of the m groups is selected, the n discharging modules α1 included in the one group can be selected at the same time. The same number m of bits of information as the number of groups is serially transferred from the main substrate β0. As described above, the enable signal HE, the discharging group selection signal and the common time-division selection signal are input to the discharging logic circuit AND1 of the discharging module α1, and thereby the discharging module α1 is selectively controlled so that a current flows through the discharging heater RhA at the corresponding position. Although an example in which n=16 and m=40 are assumed is described in this embodiment, this is not intended to be limiting. For example, n=8 and m=80 are also possible. Alternatively, for example, a different nozzle length n=32 than in this embodiment and m=40 are also possible. However, since n is the number of time divisions, n is preferably a value expressed as a power of 2 (n=2, 4, 8, 16, 32, . . . ), in order to use the output signal of the decoder circuit α22 as a selection signal.

### (Driving and Control of Circulating Module α2)

Driving and control of the circulating heater RhB in a circulating heater array α10 will be described. As with the discharging heater array α9, the circulating heater array α10 is formed by m groups. As with the discharging heater array α9, each group includes n circulating heaters RhB. The circulating heater RhB is paired with the discharging heater RhA and disposed close thereto. When one group is selected, the n circulating heaters RhB in the one group are sequentially activated in a time division manner. Driving and control of n (=16)×m (=40 groups) circulating heaters RhB will be described.

### (Time Division Control in One Group)

The circulating heater RhB is included in each circulating module α2 as described above. One group includes n circulating heaters RhB. Therefore, one group includes n circulating modules α2. Since n=16 is assumed, 16 circulating modules α2 are driven in a time division manner by a time-division selection signal. In this embodiment, the number of time divisions for the circulating modules α2 is the same as the number of time divisions for the discharge modules α1 (n=16).

### (Selective Control of Group)

To selectively drive any of the m groups, an m-bit circulating group selection signal is output from the control data supply circuit α3. When one of the m groups is selected, the n circulating modules α2 included in the one group can be selected at the same time. The same number m of bits of information as the number of groups is serially transferred from the main substrate β0. As described above, the enable signal HE, the circulating group selection signal and the common time-division selection signal are input to the circulating logic circuit AND2 of the circulating module α2, and thereby the circulating module α2 is selectively controlled so that a current flows through the circulating heater RhB at the corresponding position. However, the circulating group selection signal is transferred from the circulating group control circuit α12 via the circulating group selection signal wiring α7. The circulating group control circuit α12 is included in the control data supply circuit α3.

### (Circulating Group Control Circuit α12)

The circulating group control circuit α12 generates a circulating group selection signal according to selection information of the discharging group selection signal. FIG. 8B is a diagram showing a circuit configuration of the circulating group control circuit α12. The circulating group control circuit α12 includes a NOT circuit. A signal obtained by the NOT circuit inverting the logic of the discharging group selection signal from the discharging group selection signal wiring α6 is processed as follows. That is, the result is output to the circulating group selection signal wiring α7 as a circulating group selection signal. Therefore, when the discharging module α1 is in the selected state, the circulating module α2 is not in the selected state. On the other hand, when the discharging module α1 is not in the selected state, the circulating module α2 is in the selected state. That is, in one pair of the discharging module α1 and the circulating module α2, one of the modules is exclusively selected, or in other words, exclusively controlled. Note that while the pair is not selected in the time division control, any of the discharging module α1 and the circulating module α2 is not selected.

### (Latch Counter Circuit γ1)

After receiving a number A of edges as a set number of edges, which is a preset count value obtained by counting edges of latch signals LT, a latch counter circuit γ1 outputs a latch counter signal while a predetermined number B of subsequent edges are input. FIG. 9 is a timing chart showing a relationship between latch signals, latch counter signals and decoder signals of the latch counter circuit γ1 and the decoder circuit δ1. As shown in FIG. 9, latch signals LT continue being counted over time, and the latch counter signal is in the High state after the number A of edges is input until the number B of edges as a certain number of edges are input. At the same time, the decoder circuit δ1 outputs a decoder signal via the decoder signal wiring δ2. In this way, the circulating module α2 in the block A can be selected. Note that in FIG. 9, this decoder signal is shown as a decoder signal δ2 for the sake of convenience. In addition, as shown in FIG. 9, after the number B of edges are input, latch signals LT still continue being counted over time, and the latch counter signal is in the High state after a number C of edges as a set number of edges that is previously set is input until a number D of edges are input. At the same time, the decoder circuit δ1 outputs a decoder signal via the decoder signal wiring δ3. In this way, the circulating module α2 in the block B can be selected. Note that in FIG. 9, this decoder signal is shown as a decoder signal δ3 for the sake of convenience.

The latch counter circuit γ1 is formed by flip-flop circuits, for example. A desired number of flip-flop circuits for the number of latches to be counted can be provided. For example, when the number of latches to be counted is 1000, at least 10 stages of flip-flop circuits may be used, since the tenth power of 2 is 1024.

Note that in the example in FIG. 9, the number A of edges is set to 100000 and the number B of edges is set to 100. The numbers A and B of edges vary with the properties of the ink used or the shape of the flow channel. On the other hand, the number C of edges is set to satisfy a relation: C−(A+B)=100000 and the number D of edges is set to 100. The numbers C and D of edges vary with the properties of the ink used or the shape of the flow channel. The decoder circuit δ1 selects any of the first set of circulating modules and the second set of circulating modules each time the count value reaches a set number of edges that is previously set. Furthermore, the decoder circuit δ1 holds the selected one of the first set of circulating modules and the second set of circulating modules after the count value reaches the set number of edges until a certain number of edges are counted.

The numbers of edges vary with the heat generation amount of the circulating heater RhB. For example, in order to prevent the flow velocity of the circulating ink from becoming unstable, the number A of edges is preferably maximized, and the number B of edges is preferably minimized. Similarly, the value of C−(A+B) regarding the number C of edges is preferably maximized, and the number D of edges is preferably minimized.

Although in the example in FIG. 9, the latch counter signal rises at the rising edge of the latch signal LT, this is not intended to be limiting. For example, the latch counter signal may rise at the falling edge of the latch signal LT.

When there is only one of the block A and the block B, or when the plurality of discharging modules α1 and the plurality of circulating modules α2 are not divided into the block A and the block B, the procedure described below is also possible.

That is, a cumulative count value is used for counting the number A of edges, and the cumulative count value is initialized each time the number A of edges is exceeded. On the other hand, a differential count value that starts from the cumulative count value is used for counting the number B of edges, and the differential count value is initialized each time the number B of edges is exceeded. Furthermore, the latch counter signal is used for selective control of the circulating heater RhB. Specifically, the common time-division selection signal, the circulating group selection signal, the latch counter signal and the enable signal HE are input to the circulating logic circuit AND2. When all the input signals are 1, that is, when the logics of all the input signals are the High state, a current flows through the circulating heater RhB at the corresponding position.

Next, on the assumption that the plurality of discharging modules α1 and the plurality of circulating modules α2 are divided into the block A and the block B, a correlation between the latch signal, the decoder signal and the driving of the circulating heater will be described with reference to Table 1. Table 1 shows an example in which four stages of latch counters are used. That is, the bit configuration of the count value indicating the latch counter output is a 4-bit configuration. The counts of 4 to 7 from the latch counter circuit indicate that the circulating heater RhB in the block A is to be driven. The counts of 12 to 15 from the latch counter circuit indicate that the circulating heater RhB in the block B is to be driven. In this example, the leading bit and the second bit of the latch counter output data determine the decoder output that indicates driving of the circulating heater RhB. Specifically, when <leading bit, second bit> is <0, 1>, the circulating heater RhB in the block A is driven. When <leading bit, second bit> is <1, 1>, the circulating heater RhB in the block B is driven. When <leading bit, second bit> is any combination other than those described above, no circulating heater RhB is driven. The example shown in Table 1 shows such decoder outputs.

TABLE 1

| Latch counter output | | Decoder output | Driving of circulating heater |
|---|---|---|---|
| 0 | 0000 | | Drive no heater |
| 1 | 0001 | | |
| 2 | 0010 | | |
| 3 | 0011 | | |
| 4 | 0100 | Block A: pump ON | Drive heater in block A |
| 5 | 0101 | Block A: pump ON | |
| 6 | 0110 | Block A: pump ON | |
| 7 | 0111 | Block A: pump ON | |
| 8 | 1000 | | Drive no heater |
| 9 | 1001 | | |
| 10 | 1010 | | |
| 11 | 1011 | | |
| 12 | 1100 | Block B: pump ON | Drive heater in block B |
| 13 | 1101 | Block B: pump ON | |
| 14 | 1110 | Block B: pump ON | |
| 15 | 1111 | Block B: pump ON | |

In this embodiment, the common power supply voltage VH (24 V, for example) is connected as the power supply voltage of the discharging module α1 and the circulating module α1, and the common GNDH is connected as the ground potential. However, in order to reduce the variation in discharge energy due to the voltage drop occurring when the discharging heater RhA and the circulating heater RhB are driven, the procedure described below is possible. That is, separate supply wiring and external connection terminals for the power supply voltage and the ground potential may be provided in the discharge element substrate α0 for the discharging module α1 and the circulating module α2. That is, the discharging module α1 and the circulating module α2 may be separately supplied with a power supply voltage from the power supply circuit β2 mounted in the main substrate β0.

In general, the drive element is operated with a higher voltage than the logic circuit, and therefore, a substrate is used which includes both a high-voltage drive element and a normal drive element. In this embodiment, the discharging drive element MD1 and the circulating drive element MD2 may be formed by a DMOS transistor (double-diffused MOSFET), which is a high-voltage MOS transistor. The discharging logic circuit AND1, the circulating logic circuit AND2, the circulating group control circuit α12, and other logic circuits including the shift registers α20a and α20b, the latch circuits α21a and α21b and the decoder circuit α22 may be formed by a low-voltage MOS transistor.

### (Circuit Footprint)

Next, differences due to the circuit arrangement will be described. The drive current for the circulating heater RhB generates thermal energy for circulating the ink in the individual flow channel. When the drive current for the circulating heater RhB is smaller than the drive current for the discharging heater RhA for discharging the ink onto the discharged medium, the current driving capacity of the DMOS transistor can be low. Therefore, the footprint of the discharging drive element MD1 does not have to be larger than the footprint of the circulating drive element MD2, so that the footprint of the circulating drive element MD2 is preferably smaller than the footprint of the discharging drive element MD1.

### (First Example of Circuit Arrangement)

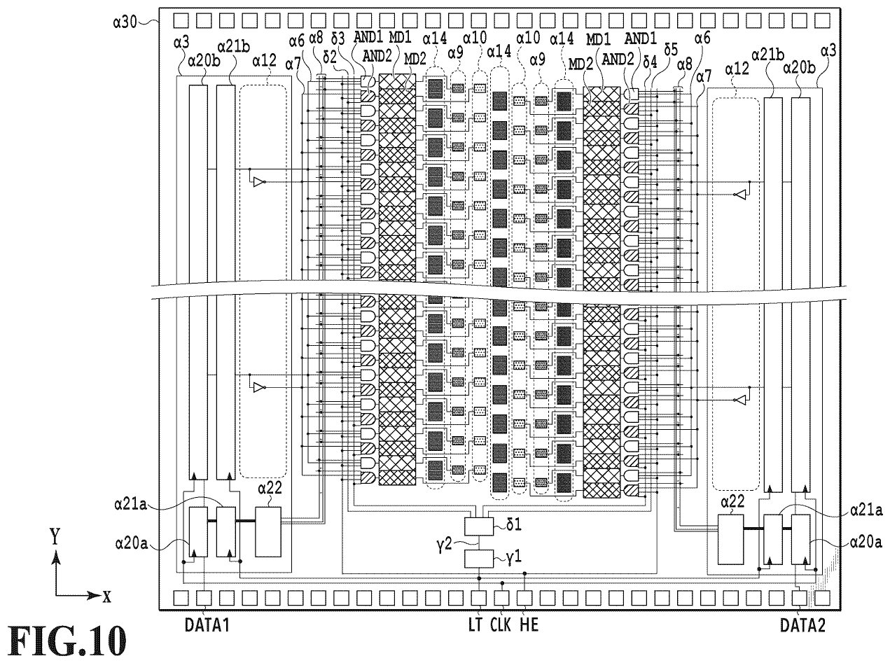

FIG. 10 is a plan view of a discharge element substrate α30. In FIG. 10, two control data supply circuits α3 are arranged at the left and right ends of the discharge element substrate α30 in the X direction. Mechanisms to be selectively driven are arranged in two systems each including the control data supply circuit α3, the discharging heater array α9 and the circulating heater array α10 and mechanisms arranged therebetween. In FIG. 10, three ink supply port arrays α14 extending in the conveyance direction Y are arranged at intervals in the direction X. Between the adjacent ink supply port arrays α14, one discharging heater array α9 and one circulating heater array α10 are arranged along the conveyance direction Y. In each of the region to the left of the left-side ink supply port array α14 of the three ink supply port arrays α14 and the region to the right of the right-side ink supply port array α14, the following components are arranged. That is, the discharging drive element MD1, the circulating drive element MD2, the discharging logic circuit AND1, the circulating logic circuit AND2, the discharging group selection signal wiring α6, the circulating group selection signal wiring α7 and the common time-division selection signal wiring α8 are arranged. The latch signal generated by the latch counter circuit γ1 is input to the decoder circuit δ1 via the latch counter signal wiring γ2. The decoder circuit δ1 supplies a decoder signal to each component via the decoder signal wiring δ2, the decoder signal wiring δ3, decoder signal wiring δ4 or decoder signal wiring δ5.

A plurality of external connection terminals are arranged along the direction X at two ends of the discharge element substrate α30 in the conveyance direction Y. By arranging the plurality of external connection terminals, external connection terminal arrays are formed. The external connection terminal arrays are arranged orthogonal to the discharging heater array α9 and the circulating heater array α10. Compared with the discharge element substrate α0, in the discharge element substrate α30, the control data supply circuits α3 are arranged in the direction X. Therefore, compared with the discharge element substrate α0, the discharge element substrate α30 can be reduced in substrate dimension in the conveyance direction Y, although the discharge element substrate α30 has a larger substrate dimension in the direction X.

Note that also in the arrangement in FIG. 10, the decoder circuit δ1 is unnecessary when there is only one of the block A and the block B. Alternatively, when the plurality of discharging modules α1 and the plurality of circulating modules α2 are not divided into the block A and the block B, the decoder circuit δ1 is unnecessary.

### (Second Example of Circuit Arrangement)

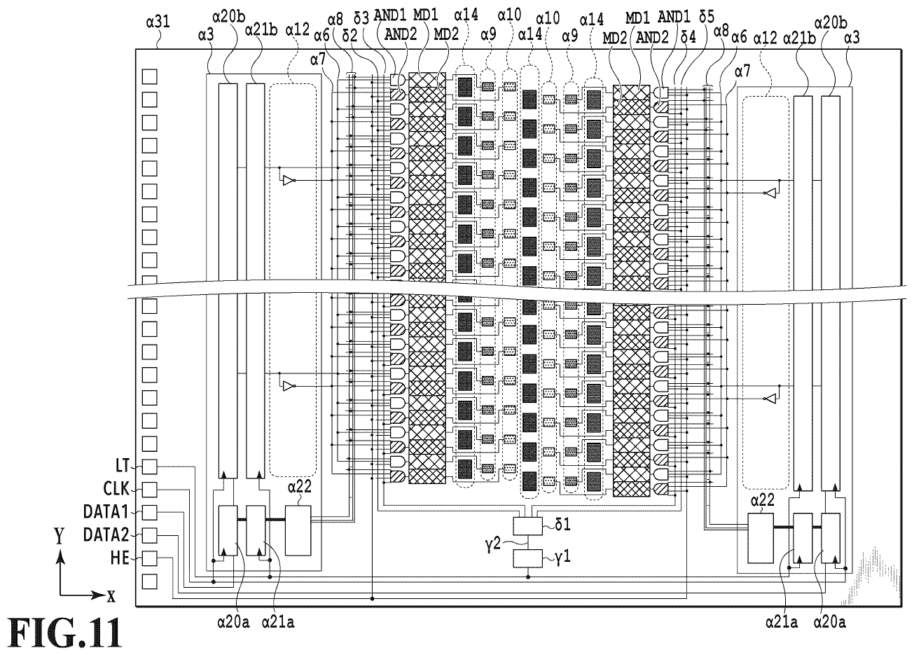

FIG. 11 is a plan view of a discharge element substrate α31. The discharge element substrate α31 in FIG. 11 has external connection terminals at the left side in the direction X. Compared with the discharge element substrate α30 in FIG. 10, the substrate dimension in the conveyance direction Y can be reduced. Although not shown, it is assumed that the discharge element substrate α31 has one unit of wiring arrangement. On this assumption, when a plurality of discharge element substrates α31 are arranged in the direction of extension of the ink supply port arrays α14, the spacings between the discharge element substrates α31 can be reduced in this arrangement, in which the external connection terminals are not provided on extension lines of the ink supply port arrays α14. That is, when the liquid discharge head 1 includes a plurality of discharge element substrates α31 arranged in the direction of extension of nozzle arrays, each discharge element substrate α31 having external connection terminals that are not provided on extension lines of the nozzle arrays, the size of the liquid discharge head 1 can be reduced. Note that in FIG. 11, the external connection terminal array is arranged in parallel with the discharging heater array α9 and the circulating heater array α10.

### (Third Example of Circuit Arrangement)

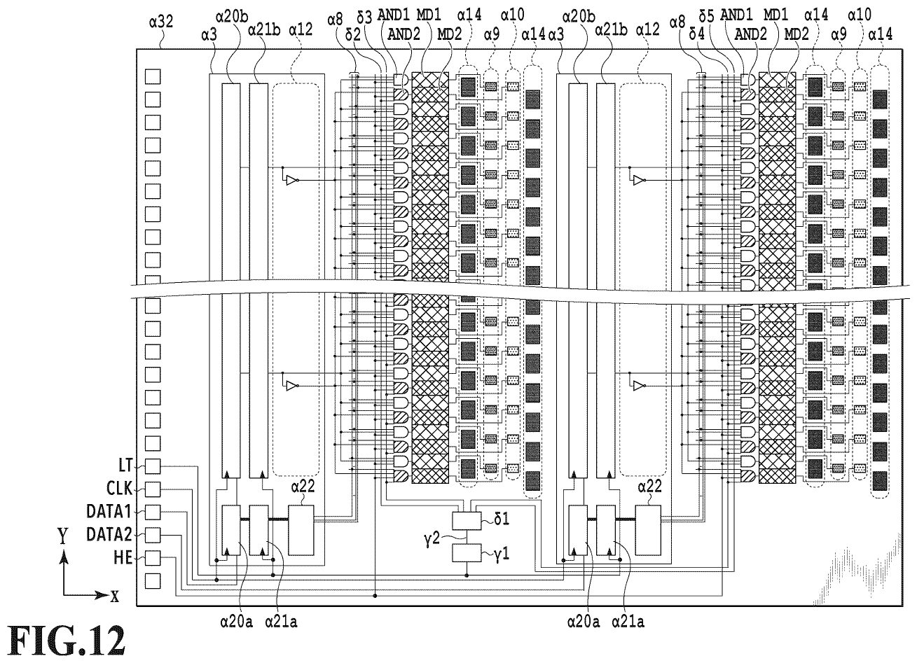

FIG. 12 is a plan view of a discharge element substrate α32. In FIG. 12, units each including the control data supply circuit α3, the ink supply port array α14, the discharging heater array α9, the circulating heater array α10, the ink supply port array α14 and the like are arranged side by side in the direction X. In this arrangement, the ink supply port array α14 of each unit is spaced apart from the ink supply port array α14 of another unit, assuming that different types of ink are supplied to different ink supply port arrays α14 on the discharge element substrate α32. With this arrangement, mixing of different types of ink can be prevented during discharge. Note that in FIG. 12, the external connection terminal array is arranged in parallel with the discharging heater array α9 and the circulating heater array α10.

### Other Embodiments

Although various examples and an embodiment have been described above, the spirit and scope of the present disclosure are not limited to the specific description in this specification. The present disclosure is not limited to the embodiment described above, and various modifications can be made. In addition, parts of the embodiment of the present disclosure described above may be appropriately combined.

### (Variation 1)

For example, although this embodiment has been described with reference to an example in which the discharging drive element MD1 and the circulating drive element MD2 are formed by a DMOS transistor, this is not intended to be limiting. For example, at least one of the discharging drive element MD1 and the circulating drive element MD2 may be formed by a silicon carbide (SiC) MOSFET.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in a discharge element substrate including discharging drive elements and circulating drive elements, the circulating drive elements can be driven an optimal number of times of driving while reducing the amount of transferred data and avoiding intensive power consumption of some of the circulating drive elements.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-159098, filed Sep. 13, 2024 and No. 2025-101373, filed Jun. 17, 2025 which are hereby incorporated by reference herein in its entirety.

What is claimed is:

1. A liquid discharge head, comprising:
a plurality of discharging modules having a discharging drive element and a discharging heater electrically connected to the discharging drive element;
a plurality of circulating modules having a circulating drive element and a circulating heater electrically connected to the circulating drive element, the circulating modules being arranged in pair with the discharging modules, and a number of the circulating modules being the same as a number of the discharging modules;
a latch circuit for latching a data signal including selection information for selecting each of the plurality of discharging modules and the plurality of circulating modules; and
a control unit for selectively controlling a first set of circulating modules or a second set of circulating modules among the plurality of circulating modules based on a count value of edges of latch signals producing latch timings for the latch circuit to latch the data signal, the second set of circulating modules arranged in a different placement area than the first set of circulating modules.

2. The liquid discharge head according to claim 1, wherein the control unit comprises:
a latch counter circuit for counting a number of edges of a latch signal and for setting the number of edges as the count value; and
a decoder circuit for selecting either the first set of circulating modules or the second set of circulating modules each time the count value for reaching a preset number of edges.

3. The liquid discharge head according to claim 2, wherein the decoder circuit holds the selected one of the first set of circulating modules and the second set of circulating modules after the count value reaches the preset number of edges until a certain number of edges are counted.

4. The liquid discharge head according to claim 3, wherein the preset number of edges is greater than the certain number of edges.

5. The liquid discharge head according to claim 1, wherein a first set of discharging modules among the plurality of discharging modules and the first set of circulating modules are arranged in a first block,
a second set of discharging modules among the plurality of discharging modules and the second set of circulating modules are arranged in a second block, and
the liquid discharge head further comprises a control data supply circuit that selectively controls each of the discharging modules and each of the circulating modules included in the first block or each of the discharging modules and each of the circulating modules included in the second block based on a common time-division selection signal derived from a bit configuration of the count value.

6. The liquid discharge head according to claim 5, wherein the control data supply circuit exclusively controls the discharging module or the circulating module based on the selection information and the common time-division selection signal.

7. The liquid discharge head according to claim 1, further comprising:
a discharge orifice for discharging a liquid being charged into a pressure chamber by the discharging heater,
wherein the discharge orifice is provided at a position corresponding to the discharging heater and the discharge orifice is not provided at a position corresponding to the circulating heater.

8. The liquid discharge head according to claim 7, wherein the circulating heater is paired with the discharging heater and is arranged in an individual flow channel including the pressure chamber.

9. The liquid discharge head according to claim 1, further comprising:
an external connection terminal array in which a plurality of external connection terminals to which the data signal is input are arranged,
wherein the external connection terminal array is arranged orthogonally to a discharging heater array in which the discharging heaters are arranged and a circulating heater array in which the circulating heaters are arranged.

10. The liquid discharge head according to claim 9, wherein the discharging drive elements are arranged along the discharging heaters, and
the circulating drive elements are arranged along the circulating heaters.

11. The liquid discharge head according to claim 1, further comprising:
an external connection terminal array in which a plurality of external connection terminals to which the data signal is input are arranged,
wherein the external connection terminal array is arranged in parallel with a discharging heater array in which the discharging heaters are arranged and a circulating heater array in which the circulating heaters are arranged.

12. The liquid discharge head according to claim 1, wherein a common power supply voltage and a common ground potential are connected to the discharging heaters and the circulating heaters.

13. The liquid discharge head according to claim 1, wherein the discharging heaters and the circulating heaters are produced in a same semiconductor process.

14. The liquid discharge head according to claim 1, wherein the discharging heaters and the circulating heaters are made of a same material.
